(19) United States
(12) Patent Application Publication
(10) Pub. No.: US 2022/0144069 A1
(43) Pub. Date: May 12, 2022

(54) Clutch Assembly, Motor Vehicle Powertrain, and Method for Operating a Powertrain

(71) Applicant: ZF Friedrichshafen AG, Friedrichshafen (DE)

(72) Inventors: Stefan Beck, Eriskirch (DE); Martin Brehmer, Tettnang (DE); Peter Ziemer, Tettnang (DE); Michael Wechs, Weißensberg (DE); Fabian Kutter, Kressbronn (DE); Matthias Horn, Tettnang (DE); Thomas Martin, Weissensberg (DE); Oliver Bayer, Hörbranz (AT); Thomas Kroh, Lindau (DE); Johannes Kaltenbach, Friedrichshafen (DE); Max Bachmann, Friedrichshafen (DE)

(21) Appl. No.: 17/435,940

(22) PCT Filed: Oct. 15, 2019
(86) PCT No.: PCT/EP2019/077942

§ 371 Date: Sep. 2, 2021

(30) Foreign Application Priority Data
Mar. 5, 2019 (DE) 10 2019 202 961.2

(51) Int. Cl. B60K 6/387; F16D 21/06; B60K 6/36; B60K 6/547; B60K 6/44

(52) U.S. Cl. CPC B60K 6/387; F16D 21/06; B60K 6/36; B60K 6/547; F16D 2021/0692; B60Y 2200/92; F16H 2200/0069; F16D 2021/0676; B60K 6/44

(57) ABSTRACT

A clutch assembly for a motor vehicle drive train includes a first clutch having a first output element, where the first clutch is a friction-locking clutch. The clutch assembly further includes a second clutch having a second output element, where the second clutch is a form-locking clutch, and where the first clutch and the second clutch have a shared input element. Additionally, the clutch assembly includes a single sliding element associated with the first clutch and the second clutch, the sliding element being movable by a single actuating unit between a first engagement position and a second engagement position axially offset from the first engagement position. The first clutch is engaged when the sliding element is in the first engagement position and the second clutch is engaged when the sliding element is in the second engagement position.

### CROSS-REFERENCE TO RELATED APPLICATION

The present application is related and has right of priority to German Patent Application No. 10 2019 202 961.2 filed on Mar. 5, 2019, and is a nationalization of PCT/EP2019/077942 filed in the European Patent Office on Oct. 15, 2019, both of which are incorporated by reference in their entirety for all purposes.

### FIELD OF THE INVENTION

The present invention relates to a clutch assembly for a motor vehicle drive train, the clutch assembly including a first clutch and a second clutch, wherein the first and second clutches have a shared input element, wherein the first clutch includes a first output element, and wherein the second clutch includes a second output element.

The invention further relates to a drive train for a motor vehicle, with this type of clutch assembly and with a transmission arrangement including a first sub-transmission and a second sub-transmission, wherein an input shaft of the first sub-transmission is connected to the first output element, and wherein an input shaft of the second sub-transmission is connected to the second output element.

Finally, the present invention relates to a method for operating a drive train of this type.

### BACKGROUND

A drive train of the above-described type is known from document DE 10 2006 036 758 A1. The automated dual clutch transmission disclosed therein includes two input shafts and at least one output shaft and an unsynchronized gear clutch, each of the input shafts is associated with a separate motor/engine clutch for connection to the drive shaft of a prime mover and with a group of gear-step gearwheels for connection to the output shaft, each of the gear-step gearwheels having different ratios and each including one fixed gear and one idler gear engageable by an associated gear clutch. In order to simplify the configuration and the controllability, the two clutches are unsynchronized dog clutches. Two electric machines, which are alternately drivingly connected to one of the input shafts, are provided as starting and synchronizing means.

Dual clutch transmissions have represented an alternative to torque converter automatic transmissions for several years. Dual clutch transmissions have a dual clutch assembly, which is connectable on the input side to a prime mover such as an internal combustion engine. An output element of a first friction clutch of the clutch assembly is connected to a first input shaft of a first sub-transmission, which is typically associated with the even forward gear steps or with the odd forward gear steps. An output element of a second friction clutch of the dual clutch assembly is connected to a second input shaft of a second sub-transmission, which is typically associated with the other forward gear steps.

The gear steps associated with the sub-transmissions is generally engaged and disengaged in an automated manner. During normal operation, one of the clutches of the dual clutch assembly is engaged. In the other, inactive, sub-transmission, a connecting gear step is then engaged in advance. A gear change is then carried out essentially without interruption of tractive force by an overlapping actuation of the two friction clutches. The friction clutches of these types of dual-clutch assemblies are generally normally disengaged friction clutches. Moreover, the transmission of torque via friction clutches of this type generally takes place in a force-fit or frictional connection. In emergency situations (for example, during a full brake application or during a malfunction of the internal combustion engine), a disengagement of these types of friction clutches also takes place under load.

Gearshift clutches for engaging and disengaging gear steps in a typical countershaft transmission are generally form-locking clutches. In many cases, a mechanical synchronization is associated with these gearshift clutches. In the engaged condition, such form-locking clutches frequently have so-called “undercuts,” and so a disengagement of such form-locking gearshift clutches is more difficult under load.

Motor vehicle transmissions are generally for either the front or the rear transverse installation in a motor vehicle, wherein attention is paid, in particular, to a short axial installation length. Alternatively, transmissions are for a longitudinal installation in a motor vehicle, wherein attention is paid, in particular, to a radially compact design.

In the front-mounted and rear-mounted transverse transmissions, two countershafts arranged axially parallel are frequently associated with an input shaft arrangement, so the power flow takes place from the input shaft arrangement either via the one countershaft or via the other countershaft. The output shafts are also countershafts and, in general, are both in engagement with a differential for distributing input power to driven wheels.

A further trend in the field of motor vehicle drive trains is so-called “hybridization.” In general, hybridization means a prime mover in the form of an internal combustion engine is associated with an electric machine, as a further prime mover. Here, a distinction is made between a plurality of different concepts, which each provide a different connection of the electric machine to the transmission. In a typical variant of dual clutch transmissions, an electric machine is arranged concentrically to an input element of the dual clutch assembly. In order to be able to utilize the electric machine, in this case, not only for assisting the internal combustion engine, but rather also to be able to set up a purely electric motor-driven operation, the input element of the dual clutch assembly is generally connected to the internal combustion engine by a separating clutch or an internal combustion engine-decoupling device.

The hybridization of transmissions, with respect to the requirements mentioned at the outset, places high requirements on radial and/or axial installation space.

In the dual clutch transmission described in DE 10 2006 036 758 A1 mentioned at the outset, an electric machine is associated with each sub-transmission.

Moreover, the dual clutch assembly is formed by two unsynchronized dog clutches. The rotational-speed adaptations necessary for the starting operation and for the synchronization during gear changes are implemented by the electric machines. The unsynchronized dog clutches are combined in a shared clutch block, which has two engagement positions, in which one of the two clutches is engaged in each case, and a neutral position with a completely interrupted power flow. During gear changes in an internal combustion engine-driven operation, a changeover of the clutches of the dual clutch assembly is always necessary. Moreover, depending on the type of the gear change, one or both electric machine(s) must be actuated for the synchronization and/or for the load transfer.

Against this background, one problem addressed by the present invention is to provide an improved clutch assembly for a motor vehicle drive train, an improved drive train for a motor vehicle, and an improved method for operating a drive train of this type.

### SUMMARY OF THE INVENTION

The above-described problem is solved, on the one hand, by a clutch assembly for a motor vehicle drive train, which has a first clutch and a second clutch. The first and second clutches include a shared input element, the first clutch includes a first output element, and the second clutch includes a second output element. The first clutch is a friction-locking clutch, and the second clutch is a form-locking clutch. A single sliding element is associated with the first clutch and the second clutch, which is movable by a single actuating unit into a first engagement position and into an axially offset second engagement position, in order to alternately engage the first clutch or the second clutch.

Moreover, the above-described problem is solved by a drive train for a motor vehicle, with this type of clutch assembly and with a transmission arrangement, which includes a first sub-transmission and a second sub-transmission, wherein an input shaft of the first sub-transmission is connected to the first output element and wherein an input shaft of the second sub-transmission is connected to the second output element.

Finally, the above-described problem is solved by a method for operating a drive train of the type according to the invention, including the steps, in a serial operation, of disengaging the first clutch, engaging the second clutch, in order to drive the second electric machine by internal combustion engine-generated power and operate the second electric machine as a generator, and providing input power by the first electric machine for establishing a driving operation.

The clutch assembly according to the invention makes it possible, during a transmission of power via the first clutch, that this clutch is also disengageable under load in an emergency situation, since it is a friction-locking clutch.

By being able to alternately engage the first clutch and the second clutch by a single sliding element, the clutch assembly is actuated only by a single actuating unit. The actuation effort is therefore reduced overall. In the drive train according to the invention, an actuation of all clutches, including the clutch assembly, is preferably implemented with only four actuating units.

A clutch is to be understood, in the present case, to be any type of shift element for connecting an input element to an output element or disconnecting the output element from the input element. In the present context, a clutch is therefore a friction-locking clutch as well as a form-locking clutch. The two elements, which are connected or disconnected from one another by a clutch, are each rotary elements such as, for example, a shaft and an idler gear, or two shafts. Alternatively, it is also possible that the clutch connects two elements to each other, of which one is fixed to the housing, such as, for example, in the case of a brake.

The single sliding element is preferably rotationally fixed to the input element.

The single actuating unit, which axially displaces the single sliding element, includes an actuator. The actuator is a hydraulic actuator, an electric motor-operated actuator, an electro-hydraulic actuator, or an electromagnetic actuator.

The problem is therefore solved in its entirety.

In one particularly preferred embodiment, the sliding element has an axial neutral position between the engagement positions, in which both the first clutch as well as the second clutch are disengaged.

As a result, it is possible to decouple both output elements from the input element, for example, in a hybrid drive train during an electric motor-driven operation.

According to one further preferred embodiment, the first clutch includes a piston, by which a friction interface arrangement of the first clutch is compressible, in order to establish a frictional connection.

The friction interface arrangement is, for example, a disk pack of a first clutch, which is a multi-disk clutch.

It is particularly preferred when the piston is rotationally fixed to the sliding element.

In this embodiment, the piston is preferably rotationally fixed to the input element, for example, to a disk carrier of the input element. The sliding element in this embodiment is preferably rotatably mounted at an input shaft connected to one of the output elements, in particular at the first input shaft. Moreover, the sliding element is preferably mounted so as to be axially displaceable with respect to the first input shaft.

According to one further preferred embodiment, the sliding element includes an axial bearing, via which the actuating unit moves the sliding element in the direction of the first engagement position, in order to engage the first clutch.

This is particularly preferred when the sliding element has a first shoulder, at which the axial bearing is arranged and via which an axial load applied by the actuating unit is preferably transmitted onto the sliding element and, consequently, the piston.

The axial bearing is preferably arranged at the sliding element such that the actuating unit acts directly at the axial bearing.

According to one further preferred embodiment, the sliding element has a second shoulder, via which the actuating unit moves the sliding element into the second engagement position, in order to engage the second clutch.

The second shoulder is preferably rigidly connected to the sliding element. In general, it is also conceivable, in fact, to allow the actuating unit to act upon the second shoulder via a second axial bearing. Since the axial loads necessary for engaging the second clutch are comparatively low, however, it is preferred to allow the actuating unit to act directly upon the second shoulder.

In the drive train according to the invention, it is preferred when the drive train includes a first electric machine, which is connected to the first input shaft, and/or a second electric machine, which is connected to the second input shaft.

As a result, a hybrid drive train is implemented, which makes all hybrid functions possible, of which a few are described in detail below.

Moreover, it is particularly preferred with respect to the drive train according to the invention when the drive train includes a third clutch for connecting the first sub-transmission and the second sub-transmission.

A method for operating a drive train is preferred, that includes, during an internal combustion engine-driven operation or a hybrid operation, utilizing the gear steps of the one sub-transmission by engaging the associated clutch of the dual clutch assembly and utilizing the gear steps of the other sub-transmission by engaging the same clutch of the clutch assembly and the third clutch.

Moreover, a method for operating a hybrid drive train of the type according to the invention is preferred, including, in an internal combustion engine-driven operation, disengaging the third clutch in a gear step of the other sub-transmission in order to decouple the other sub-transmission and the electric machine associated with the other sub-transmission.

Moreover, a method for operating a hybrid drive train of the type according to the invention is preferred, including, in a purely electric motor-driven operation, providing input power of the first electric machine via the first sub-transmission and simultaneously providing input power of the second electric machine via the second sub-transmission, wherein a powershift is implemented, in that one of the electric machines maintains the tractive force via the associated sub-transmission, while a gear change is carried out in the other sub-transmission.

The hybrid drive train according to the invention makes it possible, due to the provision of the third clutch for connecting the first sub-transmission and the second sub-transmission, that gear changes be carried out in an internal combustion engine-driven operation or in a hybrid operation without the need to actuate the clutch assembly, which is also referred to below as a dual clutch assembly. Moreover, since a separate electric machine is preferably associated with each sub-transmission, both electric machines are provided for making input power available.

In addition, both electric machines are utilized as a generator or as a motor in a serial operation. In the present case, a serial operation is understood to mean that, in a purely electric motor-driven operation by one of the two electric machines, the other electric machine is simultaneously driven by the internal combustion engine and operated as a generator, in order to charge a vehicle battery. The vehicle battery is preferably the same battery from which the electric machine operating as a motor withdraws power.

In addition, with the hybrid drive train according to the invention, it is possible to utilize an electric machine for synchronization during gear changes in an internal combustion engine-driven operation or a hybrid operation, i.e., to assist the internal combustion engine during synchronization by means of an electric machine. In other words, in the internal combustion engine-driven operation or in the hybrid operation, one of the electric machines is always connected to the internal combustion engine. As a result, a load-point displacement at the internal combustion engine is possible and this electric machine assists during the closed-loop control of the rotational speed when a shift element, such as a gearshift clutch, must be synchronized. Consequently, the internal combustion engine does not need to synchronize “on its own”, but rather is always “picked up” at its current rotational speed by one of the two electric machines.

In the internal combustion engine-driven operation or in the hybrid operation, upon implementation of one embodiment of a method according to the invention, the one clutch of the one sub-transmission remains engaged for all conditions of this operation, while the other clutch of the dual clutch assembly always remains disengaged during all conditions of this operation.

In a purely electric motor-driven operation, it is possible with the hybrid drive train according to the invention to disengage both clutches of the dual clutch assembly and to engage the third clutch, and so the two electric machines are coupled to one another and, jointly, provide input power via a single gear step. Alternatively, it is possible, in a purely electric motor-driven operation, to operate the two electric machines in parallel via their particular sub-transmissions and to leave the third clutch disengaged.

The second clutch of the dual clutch assembly, which is preferably always disengaged in the normal internal combustion engine-driven operation and in the normal hybrid operation, is preferably engaged during the serial operation. In the serial operation, one electric machine operates as a motor and provides electric motor-generated power for a purely electric motor-driven operation, for example, for an operation in a starting gear step (first gear), in order to drive a vehicle in a so-called “crawler gear”. In a crawler gear of this type, the ground speed of the vehicle is generally below a speed, at which the internal combustion engine is utilized as a prime mover (due to the ratio of the lowest gear step or starting gear step). In order to also be able to permanently establish a low ground speed of this type beyond the maximum capacity of the vehicle battery, the above-described serial operation is implemented.

In the transmission arrangement, the first input shaft and the second input shaft are preferably arranged coaxially to one another. The first input shaft is preferably an inner shaft. The second input shaft is preferably a hollow shaft. The transmission arrangement preferably includes precisely one countershaft. Preferably, the one countershaft is simultaneously an output shaft of the transmission arrangement. For this purpose, the countershaft is preferably connected to an output gear for driving a power distribution arrangement, such as a differential.

Engageable gear sets are understood to be, in the present case, gear sets that include an idler gear and a fixed gear which are in engagement with one another in an intermeshed manner, and which are engageable by an associated gearshift clutch. In an engaged gear set, the idler gear of this gear set is rotationally fixed to the associated shaft. The gear sets are preferably spur gear trains, which preferably connect one of the two input shafts and the countershaft to one another, in each case.

Associated with each gear set, preferably, is a regular forward gear step, i.e., a fixed ratio. The transmission arrangement preferably does not include a gear set, with which a reverse gear step is associated. Travel in reverse is preferably implemented exclusively via one of the electric machines.

The third clutch preferably connects the first input shaft and the second input shaft. The third clutch is preferably not a clutch of the type that is utilized for establishing a so-called “winding-path gear step” in the transmission arrangement. This is the case because, during the establishment of a winding-path gear step, two gear sets of each of the two sub-transmissions are generally involved, in order to implement a ratio that is as low as possible or a ratio that is as high as possible, i.e., in order to allow for a high spread of gear ratios of the transmission arrangement. In the present case, however, power is preferably always transmitted only via one gear set either from the first input shaft to the countershaft or from the second input shaft to the countershaft, and so the spread of gear ratios of the transmission arrangement results preferably exclusively due to the ratios of the regular forward gear steps. Consequently, the transmission arrangement generally operates with a high efficiency.

In one preferred embodiment, the first sub-transmission is associated with the odd gear steps. In a corresponding way, the second sub-transmission in one preferred embodiment is associated with the even forward gear steps.

In the present case, a connection is understood to mean, in particular, that the two elements connected to one another are permanently connected to each other in a rotationally fixed manner. Alternatively, or as necessary, they are “connectable” to each other in a rotationally fixed manner. In the present case, a rotationally fixed connection is understood to mean that the elements connected in this way rotate at a rotational speed proportional to one another, in particular at the same rotational speed.

The electric machines are preferably arranged axially parallel to the transmission arrangement. Consequently, the longitudinal axes of the electric machines are preferably arranged in parallel, although offset with respect to the input shafts as well as to the countershaft.

In a preferred variant, the order of the elements starting from an input of the transmission arrangement is as follows: fifth gear set for the fourth forward gear step, gearshift clutch assembly for the second and fourth forward gear steps, gear set for the second forward gear step, gearshift clutch assembly with the third clutch and a gearshift clutch for the third forward gear step (or the fifth forward gear step), gear set for the third forward gear step (or fifth forward gear step), gear set for the first forward gear step 1, gearshift clutch assembly for the first and third forward gear steps (or first and fifth forward gear steps), and gear set for the fifth forward gear step (or third forward gear step).

The gearshift clutch assemblies for the second and fourth forward gear steps as well as first and third forward gear steps (or first and fifth forward gear steps) are preferably arranged at a countershaft. A gearshift clutch assembly, which includes the third clutch and a gearshift clutch for the fifth or third forward gear step, is preferably arranged coaxially to the input shafts.

In general, a gearshift clutch assembly is understood to be an arrangement of two gearshift clutches, which are alternately actuatable by one single actuating unit. Moreover, a gearshift clutch assembly generally has a neutral position, in which neither of the two gearshift clutches of the assembly is engaged. A gearshift clutch assembly of this type is also referred to as a double shift element. A gearshift clutch is generally a form-locking clutch, which, in principle, is synchronized (with a mechanical synchronization) or is non-synchronized.

It is particularly preferred when the gear set that is engageable by the gearshift clutch assembly is associated with the sub-transmission, the associated clutch of which is always engaged in the internal combustion engine-driven operation and in the hybrid operation. Preferably, this gear set is associated with the first sub-transmission, which is associated with the odd forward gear steps. It is particularly preferred when the gear set is associated with the fifth forward gear step or the third forward gear step.

According to one further preferred embodiment, the first clutch of the dual clutch assembly, the second clutch of the dual clutch assembly, the third clutch, and/or at least one gearshift clutch of the transmission arrangement is a dog clutch, i.e., an unsynchronized shift element. A dog clutch of this type includes, in particular, no friction elements for synchronizing components to be connected to each another.

Due to the fact that a separate electric machine is associated with each sub-transmission, functions of the synchronization and/or of the load transfer take place by the electric machines. Accordingly, the above-mentioned clutches are dog clutches, so potential for the reduction of the axial and/or radial installation space results, as well as weight advantages.

In a further embodiment preferred overall, the first electric machine is connected to the first input shaft via a gear-step gear set of the first sub-transmission and/or the second electric machine is connected to the second input shaft via a gear-step gear set of the second sub-transmission.

In general, it is conceivable to arrange the electric machines coaxially to, for example, the particular input shaft of the sub-transmissions. It is preferred, however, that the electric machines are arranged axially parallel to the input shaft arrangement. The connection to the particular input shaft then takes place via a flexible traction drive mechanism or a gear set. A separate gear set is provided for this purpose. This has the advantage of a connection having an optimized ratio. As mentioned above, it is preferred, however, when the connection of the electric machines takes place via particular gear-step gear sets. Weight is saved as a result. A ratio adaptation preferably takes place in that a machine pinion of the particular electric machine is not directly connected to a gearwheel of the gear-step gear set or is in engagement therewith in an intermeshed manner, but rather that an intermediate gear is intermediately connected, and so the electric machines are connected to the particular sub-transmissions with an optimized ratio. In particular, the electric machines are implemented as relatively high-speed machines, which, consequently, are compact.

It is particularly preferred when the gear-step gear set of the first sub-transmission, via which the first electric machine is connected to the first input shaft, is associated with the highest gear step of the first sub-transmission, and/or when the gear-step gear set of the second sub-transmission, via which the second electric machine is connected to the second input shaft, is associated with the highest gear step of the second sub-transmission.

According to one further preferred embodiment, the gear-step gear set of the first sub-transmission, via which the first electric machine is connected to the first input shaft, is arranged at a first axial end of the transmission arrangement, and/or the gear-step gear set of the second sub-transmission, via which the second electric machine is connected to the second input shaft, is arranged at a second axial end of the transmission arrangement.

This allows for a connection of the electric machine, on the one hand, at the points, at which high bearing forces is absorbed, since housing walls or bearing plates are generally arranged at the axial ends of the transmission arrangement. Moreover, this allows for a connection of the electric machines such that these connections remain as unaffected as possible from one another. In addition, this type of connection makes it possible for the electric machines to be arranged in axial overlap with one another. It is particularly preferred when the first electric machine and/or the second electric machine extend(s) between the first axial end of the transmission arrangement and the second axial end of the transmission arrangement. As a result, an axially compact design is also implemented.

According to one further embodiment preferred overall, the first sub-transmission is associated with the odd forward gear steps and includes three gear sets, which are associated with different forward gear steps, and/or the second sub-transmission is preferably associated with the even forward gear steps and includes two or three gear sets, which are associated with different forward gear steps.

By five or six forward gear steps, an internal combustion engine-driven operation across a large speed range is implemented. For very low speed ranges, travel takes place exclusively by electric motor, if necessary.

The transmission arrangement therefore preferably has only five or six gear set planes. Moreover, the transmission arrangement preferably has only three gearshift clutch planes, in each of which preferably precisely one gearshift clutch assembly is arranged.

Preferably, the transmission arrangement includes only precisely four actuating units, three of which are associated with the gearshift clutch assemblies of the transmission arrangement and one of which is associated with the dual clutch assembly.

According to one further embodiment preferred overall, the first electric machine and the second electric machine are identical.

This yields cost advantages and stock-control advantages. The two electric machines then operate practically “equally” within the transmission arrangement and are both operated alternately as a prime mover for driving a motor vehicle and/or as a generator for charging a vehicle battery.

Overall, by the hybrid drive train, depending on the embodiment, at least one of the following advantages is achieved:

low design complexity, since preferably only five (if necessary, six) gear set pairs and four actuating units are to be provided,

good efficiency and a simple configuration, since, in particular, no winding-path gear steps are implemented,

low component loads,

at least three electric gear steps for the first electric machine and at least two gear steps for the second electric machine,

the transmission arrangement includes preferably only one countershaft, which is preferably connected to a power distribution unit via only one output gear set,

gear change operations are carried out quickly and efficiently, since an engagement of the dual clutch assembly is not necessary in an internal combustion engine-driven operation and a hybrid operation and since the synchronization of gear steps is always implementable also by utilizing an electric machine,

a serial operation is implementable by the first electric machine and also by the second electric machine as a generator,

high versatility in combination with compact dimensions.

It is understood that the features, which are mentioned above and which will be described in greater detail in the following, are usable not only in the particular combination indicated, but also in other combinations or alone, without departing from the scope of the present invention.

### BRIEF DESCRIPTION OF THE FIGURES

Exemplary embodiments of the invention are represented in the drawing and are explained in greater detail in the following description, wherein

FIG. 1 shows a diagrammatic gear set representation of an embodiment of a hybrid drive train;

FIG. 2 shows a diagrammatic power flow representation of a further embodiment of a hybrid drive train;

FIG. 3 shows a gearshift table for an internal combustion engine-driven operation and a hybrid operation of the hybrid drive train from FIG. 1;

FIG. 4 shows a gearshift table for an electric motor-driven operation by the first electric machine;

FIG. 5 shows a gearshift table for an electric motor-driven operation by the second electric machine;

FIG. 6 shows a schematic of an embodiment of a clutch assembly according to the invention; and

FIG. 7 shows a partial longitudinal sectional representation of a further embodiment of a clutch assembly according to the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

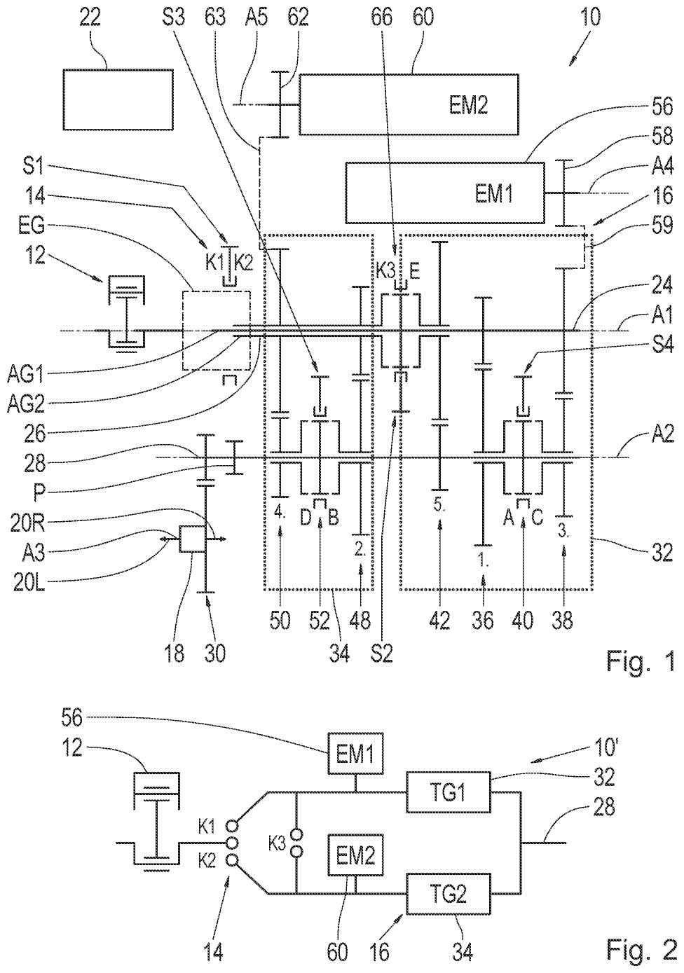

In FIG. 1, a hybrid drive train 10 for a motor vehicle, in particular a passenger car, is represented in diagrammatic form.

The hybrid drive train 10 includes an internal combustion engine 12, which is connected to an input element of a dual clutch assembly 14. The dual clutch assembly 14 is connected on the output side to a hybrid transmission arrangement 16. An output of the hybrid transmission arrangement 16 is connected to a power distribution unit 18, which is, for example, a mechanical differential that distributes the input power to two driven wheels 20L, 20R of the motor vehicle.

Moreover, the hybrid drive train 10 includes a control device 22 for controlling all components thereof.

The dual clutch assembly 14 is arranged on a first axis A1, which is coaxial to a crankshaft of the internal combustion engine 12. The dual clutch assembly 14 includes two friction clutches, or one friction clutch and an unsynchronized dog clutch. In the present case, the dual clutch assembly 14 includes two clutches, including a first clutch K1 and a second clutch K2. The two clutches K1, K2 have a shared input element EG, which is rotationally fixed to the crankshaft of the internal combustion engine 12. The first clutch K1 has a first output element AG1. The second clutch K2 has a second output element AG2. The output elements AG1, AG2 are arranged coaxially to one another.

The transmission arrangement 16 includes a first input shaft 24 and a second input shaft 26. The input shafts 24, 26 are arranged coaxially to one another and to the first axis A1. The first input shaft 24 is an inner shaft. The second input shaft 26 is a hollow shaft.

Moreover, the transmission arrangement 16 includes a countershaft 28, which is an output shaft 28 and is arranged coaxially to a second axis A2. The output shaft 28 is connected via an output gear set 30 to the power distribution unit 18, which is arranged coaxially to a third axis A3.

A parking interlock gear P is rotationally fixable at the output shaft 28 or at an input element of the power distribution unit 18. The hybrid drive train 10 is immobilized by the parking interlock gear P. The associated parking lock device is not represented, for the sake of clarity.

The transmission arrangement 16 has a first sub-transmission 32 and a second sub-transmission 34. The sub-transmissions 32, 34 are arranged axially offset with respect to one another. The first sub-transmission 32 is arranged adjacent to a first axial end of the transmission arrangement 16. The second sub-transmission 34 is arranged adjacent to a second axial end of the transmission arrangement 16, wherein the second axial end is adjacent to the dual clutch assembly 14. The sub-transmissions 32, 34 each have a plurality of engageable gear sets, which, in the engaged condition, connect an input shaft and the output shaft 28.

The first sub-transmission 32 has a first gear set 36 for a first forward gear step 1 and a second gear set 38 for a third forward gear step 3. The second gear set 38 is arranged closer to the first axial end of the transmission arrangement 16 than the first gear set 36. A first gearshift clutch assembly 40 is arranged between the first gear set 36 and the second gear set 38 and coaxially to the second axis A2. The first gearshift clutch assembly 40 includes a first gearshift clutch A for engaging the first gear set 36 and a second gearshift clutch C for engaging the second gear set 38. The two gearshift clutches A, C are alternately engageable and are unsynchronized dog clutches. The engagement of a gear set includes the rotationally fixed connection of an idler gear of the particular gear set to an associated shaft. In the present case, for example, the first gear set 36 is engaged, in that an idler gear of the first gear set 36, which is rotatably mounted at the output shaft 28, is rotationally fixed to the output shaft 28, in order to bring the first gear set into the power flow in this way.

Moreover, the first sub-transmission 32 has a third gear set 42 for a fifth forward gear step 5. The third gear set 42 is arranged closer to the second axial end of the transmission arrangement 16 than the first gear set 36.

The third gear set 42 is engageable by a third gearshift clutch E and has an idler gear, which is rotatably mounted at the first input shaft 24.

The second sub-transmission 34 has a fourth gear set 48 for a second forward gear step 2 and a fifth gear set 50 for a fourth forward gear step 4. The fifth gear set 50 is arranged closer to the second axial end than the fourth gear set 48. A second gearshift clutch assembly 52 is arranged between the fourth and fifth gear sets 48, 50 and, in fact, coaxially to the second axis A2. The second gearshift clutch assembly 52 has a fourth gearshift clutch B for engaging the fourth gear set 48 and a fifth gearshift clutch D for engaging the fifth gear set. The fourth and fifth gearshift clutches B, D are accommodated in the second gearshift clutch assembly 52 such that they are alternately actuatable.

Consequently, the transmission arrangement 16 has five gear set planes, namely, starting from the second axial end toward the first axial end, in the following order: fifth gear set 50 for the fourth forward gear step 4, fourth gear set 48 for the second forward gear step 2, third gear set 42 for the fifth forward gear step 5, first gear set 36 for the first forward gear step 1, and second gear set 38 for the third forward gear step 3.

Moreover, the hybrid drive train 10 includes a first electric machine 56, which is arranged coaxially to a fourth axis A4. The first electric machine 56 has a first pinion 58, which is rotationally fixed to a rotor of the first electric machine 56 and is coaxial to the fourth axis A4. The first pinion, which is also referred to as the first machine pinion, is connected to a gear-step gear set of the first sub-transmission 32, in the present case to the second gear set 38 for the third forward gear step 3 via a first intermediate gear 59 rotatably mounted at an axle (not described in greater detail). More precisely, the first pinion 58 meshes with the first intermediate gear 59, and the first intermediate gear 59 meshes with a fixed gear of the second gear set 38, where the fixed gear is rotationally fixed to the first input shaft 24.

Moreover, the hybrid drive train 10 has a second electric machine 60, which is arranged axially parallel to the input shafts 24, 26 and, in fact, coaxially to a fifth axis A5. The second electric machine has a second pinion (second machine pinion) 62 arranged coaxially to the fifth axis A5. The second pinion 62 is connected to the second input shaft 26 via a gear-step gear set of the second sub-transmission 34. In the present case, the second pinion 62 is connected to the fifth gear set 50 for the fourth forward gear step 4 via a second intermediate gear 63. More precisely, the second pinion 62 meshes with the second intermediate gear 63 rotatably mounted at an axle (not described in greater detail), and the second intermediate gear 63 meshes with a fixed gear of the fifth gear set 50, where the fixed gear is rotationally fixed to the second input shaft 26.

The five axes A1, A2, A3, A4, A5 are all aligned in parallel with one another.

The dual clutch assembly 14 is arranged adjacent to the second axial end of the transmission arrangement 16, as mentioned above. The output gear set 30 is also arranged on the second axial side of the transmission arrangement 16 and is preferably axially aligned with the dual clutch assembly 14 or is situated approximately in a plane therewith. The parking interlock gear P is fixable at the output shaft 28 between the output gear set 30 and the fifth gear set 50.

In the hybrid drive train 10, the electric machines 56, 60 are each preferably connected to a gear-step gear set of its associated sub-transmission that is associated with the highest gear step of that sub-transmission. For this purpose, it is useful in the first sub-transmission 32 to interchange the second and third gear sets 38, 42 such that the first gearshift clutch assembly 40 includes the first gearshift clutch A and the third gearshift clutch E for the fifth forward gear step 5, and the second gearshift clutch C for engaging the third forward gear step 3 is arranged at the first input shaft 24. Moreover, the electric machines 56, 60 are each connected via a gear-step gear set to its particular sub-transmission that is preferably arranged adjacent to an axial end of the transmission arrangement. The gear sets are situated at opposite axial ends.

The electric machines 56, 60 are arranged in axial overlap with one another. Due to the connection via intermediate gears 59, 63, high ratios for the particular gear-step gear sets are established, and so electric machines rotating at relatively high speeds are utilized, which are compact.

The hybrid transmission arrangement in the present case has precisely five forward gear steps and does not have a reverse gear step. An operation in reverse can be exclusively established by means of the hybrid drive train 10 when one of the electric machines 56, 60 is driven in the opposite direction of rotation.

The transmission arrangement 16 has no winding-path gear steps. Each gear set 36, 38, 42, 48, 50 includes precisely one idler gear and one fixed gear, wherein the idler gears of the first, second, fourth, and fifth gear sets 36, 38, 48, 50 are rotatably mounted at the output shaft 28, and wherein the idler gear of the third gear set 42 is rotatably mounted at the first input shaft 24.

Moreover, the hybrid drive train 10 includes a third clutch K3, which is also referred to as a “bridge clutch.”

The third clutch K3 is utilized for connecting the first input shaft 24 and the second input shaft 26. The third clutch K3 is arranged adjacent to the fourth gear set 48 for the second forward gear step 2 and is accommodated, with the third gearshift clutch E for the third gear set 42 for engaging the fifth forward gear step, in a third gearshift clutch assembly 66. The third clutch K3, just like the gearshift clutches A, B, C, D, E, is an unsynchronized dog clutch.

The third gearshift clutch assembly 66 is arranged coaxially to the first axis A1 and, in fact, between the third and fourth gear sets 42, 48.

The dual clutch assembly 14 and the three gearshift clutch assemblies 40, 52, 66 are actuatable by four actuating units S1, S2, S3, S4.

A first actuating unit S1 is utilized for actuating the dual clutch assembly 14 and engages either the first clutch K1 or the second clutch K2, or establishes a neutral position.

In a corresponding way, the first gearshift clutch assembly 40 is actuated by a fourth actuating unit S4. By the fourth actuating unit S4, either the first gearshift clutch A or the second gearshift clutch C is engaged, or a neutral position is established.

In a corresponding way, the second gearshift clutch assembly 52 is actuated by a third actuating unit S3 in order to either engage the fifth clutch D or the fourth clutch B, or to establish a neutral position.

Finally, the third gearshift clutch assembly 66 is engaged by a second actuating unit S2 in order to either engage the third clutch K3, or engage the third gearshift clutch E, or establish a neutral position.

In FIG. 2, a further embodiment of a hybrid drive train 10′ is represented, which generally corresponds to the drive train 10 from FIG. 1 with respect to the configuration and the mode of operation. Identical elements are therefore indicated by identical reference characters.

It is apparent that input power from the internal combustion engine 12 is guided either via the first clutch K1 to the first sub-transmission 32 or via the second clutch K2 to the second sub-transmission 34. Input power of the first electric machine 56 is supplied directly into the first sub-transmission 32 or toward the internal combustion engine 12 (for example, in order to start it) via the clutch K1.

Input power of the second electric machine 60 is introduced directly into the second sub-transmission 34 or to the internal combustion engine 12 via the clutch K2, for example, in order to start the internal combustion engine 12.

Moreover, it is apparent that the first sub-transmission 32 and the second sub-transmission 34 are connectable to each other via a third clutch K3, and so, for example, when the first clutch K1 is engaged, internal combustion engine-generated power flows via the third clutch K3 to the second sub-transmission 34.

In this case, the first electric machine 56 is switched to idle so it rotates in a nearly loss-free manner, or is operated as a generator or as an electric motor.

In a corresponding way, when the second clutch K2 is engaged, power of the internal combustion engine 12 is directed to the first sub-transmission 32 when the clutch K3 is engaged.

Moreover, a serial operation is possible when, for example, purely electric motor-generated input power from the first electric machine 56 is guided via the first sub-transmission 32 to the output shaft 28. In this case, with the first and third clutches K1, K3 disengaged, the second clutch K2 is engaged in order to utilize input power of the internal combustion engine 12 to drive the second electric machine 60 and to allow the second electric machine 60 to operate as a generator, which charges a battery (not represented in greater detail) of the drive train 10′. It is understood that all gearshift clutches of the second sub-transmission 34 are disengaged in this case.

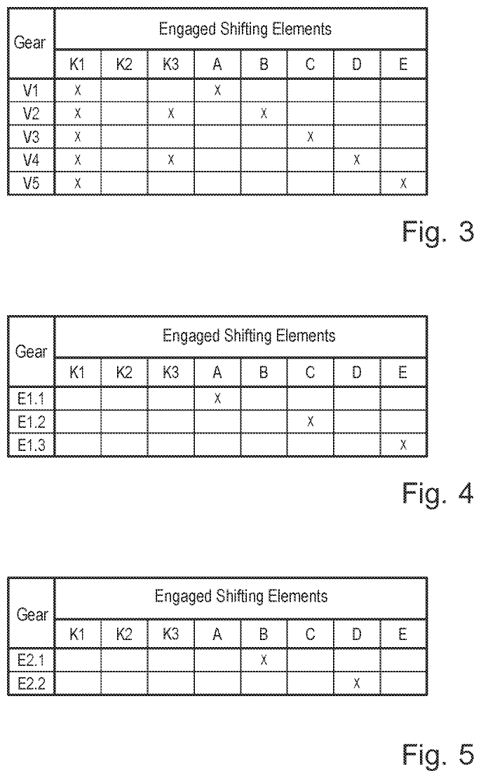

Different operations, which are establishable with the hybrid drive train 10 from FIGS. 1 and 2, are explained with reference to FIGS. 3-5.

FIG. 3 shows a gearshift table of the shift elements K1, K2, K3, A, B, C, D, E in a purely internal combustion engine-driven operation or in a hybrid operation, in which input power is made available by the internal combustion engine and, optionally, by the electric motors.

In all forward gear steps, including a first forward gear step V1, a second forward gear step V2, a third forward gear step V3, a fourth forward gear step V4, and a fifth forward gear step V5 establishable in this operation, the first clutch K1 is continuously engaged and the second clutch K2 of the dual clutch assembly 14 is continuously disengaged. In the first forward gear step V1, the first gearshift clutch A is engaged and all other gearshift clutches B, C, D, E are disengaged. The third clutch K3 is also disengaged. Consequently, power flows from the internal combustion engine 12 via the first clutch K1 and the first input shaft 24 to the first gear set 36 and, from there, via the first gearshift clutch A to the output shaft 28.

It is understood that a driving start from a standstill generally takes place purely by electric motors 56, 60 until a speed is reached at which the internal combustion engine is connected via the first clutch K1, i.e., at a speed that corresponds to a rotational speed above the idling speed of the internal combustion engine 12. Consequently, a driving start from a standstill takes place, for example, via the first electric machine 56 and the first gear set 36 for the first forward gear step V1. As soon as a speed has been reached that corresponds to the speed of the internal combustion engine 12, the first clutch K1 is engaged. The first clutch K1 remains engaged during the entire internal combustion engine-driven operation.

During the changeover from the first forward gear step V1 into the second forward gear step V2, initially the fourth gearshift clutch B for the second forward gear step V2 is preliminarily engaged. This takes place, if necessary, with the aid of a synchronization by the second electric machine 60.

Thereafter, the first gearshift clutch A for the first forward gear step V1 is disengaged, wherein the tractive force is supported by the second electric machine 60 and the already engaged gear set 48 for the second forward gear step V2. Thereafter, the third clutch K3 is engaged, wherein the synchronization necessary takes place, on the one hand, by a rotational-speed adaptation of the internal combustion engine 12, but also by appropriate synchronization measures of the second electric machine 60. In the second forward gear step V2, power consequently flows from the internal combustion engine 12 via the first clutch K1, the first input shaft 24, the engaged third clutch K3, the second input shaft 26, and the fourth gear set 48 for the second forward gear step V2, which is engaged by the fourth gearshift clutch B, to the output shaft 28.

During the changeover into the third forward gear step V3, the third clutch K3 is disengaged, the tractive force is supported via the second electric machine 60 and, thereafter, the connecting gear step 3 is engaged in the first sub-transmission 32 by engaging the second gearshift clutch C. The necessary synchronization takes place by the first electric machine 56.

Thereafter, the load is assumed by the first electric machine 56 and the fourth gearshift clutch B of the forward gear step V2 is disengaged.

The further gear changes from the third gear step V3 to the fourth gear step V4 and from the fourth gear step V4 to the fifth gear step V5 result in a corresponding way. In each of the even forward gear steps V2, V4, the third gearshift clutch K3 is engaged. The second clutch K2 is always disengaged and the first clutch K1 is always engaged.

In FIG. 4, a purely electric motor-driven operation by the first electric machine 56 is represented. In a first electric gear step E1.1, only the first gearshift clutch A for the forward gear step V1 is engaged. In a second electric forward gear step E1.2, only the second gearshift clutch C is engaged. In a third electric-motor gear step E1.3, only the third gearshift clutch E is engaged.

In a corresponding way, FIG. 5 shows a purely electric motor-driven operation by the second electric machine 60. In a first gear step E2.1, only the fourth gearshift clutch B is engaged. In a second electric gear step E2.2, only the fifth gearshift clutch D is engaged.

In the purely electric operation according to FIGS. 4 and 5, purely electric powershifts (i.e., gear changes between forward gear steps) without, or with reduced, interruption of tractive force are possible. Here, an electric motor-driven operation is established exclusively, for example, between the gear steps E1.1, E1.2, E1.3 with the first electric machine 56 or exclusively between the gear steps E2.1, E2.2 with the second electric machine 60, and a gear change takes place while the other electric machine maintains the tractive force.

During a gear change, for example, from the forward gear step E1.1 into the forward gear step E1.2, the fourth gearshift clutch B is engaged in the second sub-transmission and, consequently, the second electric machine maintains the tractive force during the gear change in the first sub-transmission.

In the purely internal combustion engine-driven operation or hybrid operation (i.e., for the case in which internal combustion engine-generated power and, optionally, electric motor-generated power are guided to the output shaft), it is advantageous that the third clutch K3 is utilized for connecting the second input shaft 26 to the first input shaft 24 and, consequently, always supplying internal combustion engine-generated power into the transmission arrangement 16 via the first input shaft 24. Consequently, the first electric machine 56 associated with the first sub-transmission 32 is always rotationally fixed to the internal combustion engine 12 during this operation. As a result, it is possible to establish load-point displacements at the internal combustion engine 12 and the first electric machine 56 that provide assistance during the closed-loop control of the rotational speed when a synchronization process is to take place. In other words, since the first clutch K1 always remains engaged, the first electric machine 56 assists the internal combustion engine 12 during synchronization.

In order to integrate the third clutch K3, which is necessary therefor, into the transmission arrangement as efficiently as possible, the third clutch K3 is accommodated in the third gearshift clutch assembly 66. Since the third clutch K3 is integrated with a gearshift clutch into a gearshift clutch assembly that is associated with that sub-transmission, and the associated first clutch K1 of the dual clutch assembly 14, is always engaged in the internal combustion engine-driven or hybrid operation, the internal combustion engine utilizes all gear steps of the transmission.

The second clutch K2 is engaged, however, when a so-called “serial operation” is established. Here, the first clutch K1 is disengaged. Via the first sub-transmission 32 and the first electric machine 56, a purely electric motor-driven operation is established in a gear step, for example, in the forward gear step 1. The internal combustion engine 12 drives the second electric machine 60 via the engaged second clutch K2 and drives it as a generator, so the power withdrawn from a vehicle battery by the first electric machine 56 in this purely electric operation is simultaneously resupplied, at least partially, via the second electric machine 60.

A serial operation of this type is also possible in reverse when travel takes place purely electrically by the second electric machine 60 and the internal combustion engine 12 drives the first electric machine 56. In the latter case, the first clutch K1 is engaged and the second clutch K2 is disengaged.

The serial operation is utilized, in particular, in a so-called “crawling mode,” in which the vehicle speed is lower than a minimum speed that is establishable by the internal combustion engine.

The sub-transmission 32 that is associated with the first clutch K1, which is always engaged in the internal combustion engine-driven mode, preferably also includes the highest forward gear step of the transmission arrangement 16. As a result, when the third clutch K3 is disengaged, the second electric machine 60 is practically decoupled in order to avoid drag losses. In addition, the first electric machine 56 remains coupled in order to supply the main power circuit with electrical energy (operation as a generator), or in order to establish a boost operation (operation as a motor).

During a gear shift from a forward gear step of the first sub-transmission 32 into a forward gear step of the second sub-transmission 34, the desired gear step is initially engaged in the second sub-transmission by engaging the associated gearshift clutch D, B. This takes place with the aid of a synchronization by the second electric machine 60, wherein the second electric machine 60 switches over, in a load-free manner, into this target gear step in the second sub-transmission 34. Thereafter, the second electric machine 60 supports the tractive force during the gear shift via the already engaged target gear step. During the gear shift, initially the gearshift clutch of the first sub-transmission, which is associated with the starting or source gear step, disengages and, thereafter, the third clutch K3 is engaged, wherein the internal combustion engine 12 and the first electric machine 56 interact during the synchronization.

During a gear shift from the second sub-transmission 34 into a gear step of the first sub-transmission 32, the second electric machine 60 initially supports the tractive force in the source gear step or the actual gear during the gear shift. During the gear shift, the third clutch K3 is initially disengaged and one of the shift elements A, C, E engages, wherein the internal combustion engine 12 and the first electric machine 56 interact during the necessary synchronization. After the disengagement of the third clutch K3 and the load transfer on the first sub-transmission 32, the output gear step (actual gear step) in the second sub-transmission is disengaged.

It is understood that a stationary charging also takes place with the hybrid drive train when the vehicle is at a standstill. For example, the first clutch K1 is engaged and input power of the internal combustion engine 12 is supplied via the first input shaft 24 into the first electric machine 56. The second clutch K2 remains disengaged and the gearshift clutches A, C, E of the first sub-transmission 32 also remain disengaged. Therefore, the first sub-transmission 32 remains in neutral. In this condition, as mentioned, either a stationary charging takes place or a start of the internal combustion engine 12 by the first electric machine 56 takes place.

In general, it is also conceivable to engage both the first and second clutches K1, K2 or to engage the first clutch K1 and the third clutch K3 in order to allow a charging process to take place by the first electric machine 56 and also by the second electric machine 60. In this case, the internal combustion engine drives both electric machines and they both operate as generators, in order to charge a vehicle battery.

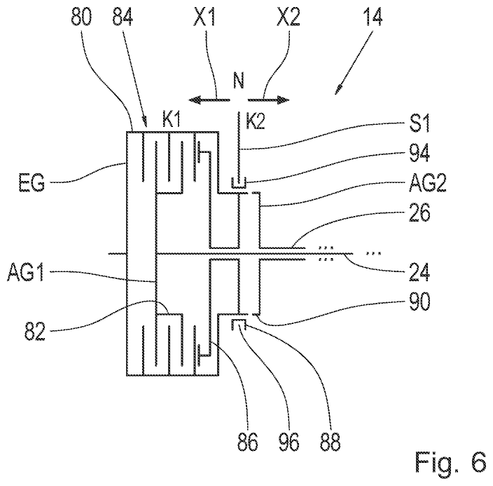

In FIG. 6, a dual-clutch assembly 14 is shown, which is usable as the dual-clutch assembly 14 of the hybrid drive train from FIG. 1.

In the dual-clutch assembly 14, the first clutch K1 is a friction-locking clutch, in particular a multi-disk clutch. The second clutch K2, however, is a form-locking clutch, in particular a non-synchronized dog clutch.

The input element EG, which is common to the two clutches K1, K2, is rotationally fixed to an outer disk carrier 80 of the first clutch K1. An inner disk carrier 82 of the first clutch K1 is rotationally fixed to the first input shaft 24. A disk pack 84 is formed between the outer disk carrier 80 and the inner disk carrier 82, which is compressible by a piston 86 in order to engage the first clutch K1. The first clutch K1 is preferably a normally disengaged clutch, which is always disengaged in the unloaded condition by a return spring force.

The clutch assembly 14 includes a single sliding element 88. The sliding element 88 is displaced into three different axial positions, into a first engagement position X1 for engaging the first clutch K1, into a second engagement position X2 for engaging the second clutch K2, and into a neutral position N situated axially therebetween.

The second clutch K2 includes an axial clutch spline 90, which is arranged at the second output element AG2. Moreover, the second clutch K2 includes an axial clutch spline 94 at the sliding element 88. The sliding element 88 is rotationally fixed to the input element EG, for example, via an axial spline (not represented in greater detail). Starting from the neutral position N represented in FIG. 6, the sliding element 88 is movable to the right by a single actuating unit S1 in order to bring the splines 90, 94 into engagement and engage the second clutch K2 in a form-locking manner. Starting from the neutral position represented in FIG. 6, the sliding element 88 is also movable in the direction of the second engagement position X1, in which an axial load is applied by the sliding element 88 onto the piston 86 in order to compress the disk pack 84.

It is understood that the first engagement position X1 is not a fixed position, but rather the first clutch K1, due to its friction-locking function, is acted upon by an axial load via the sliding element 88. The term “first engagement position” therefore corresponds, for the first clutch K1, to a position, in which a sufficient axial contact pressure is applied by the piston 86 in order to establish a friction-locking connection in the first clutch K1.

The sliding element 88 includes a synchronizer sleeve groove 96 known, per se, into which the first actuating unit S1 engages. The first actuating unit S1 is, for example, a selector fork or a swing fork, which is axially coupled to an axially displaceable shift rail (not represented). Such a shift rail is axially displaced by a suitable actuator, in order to establish the positions X1, X2, N.

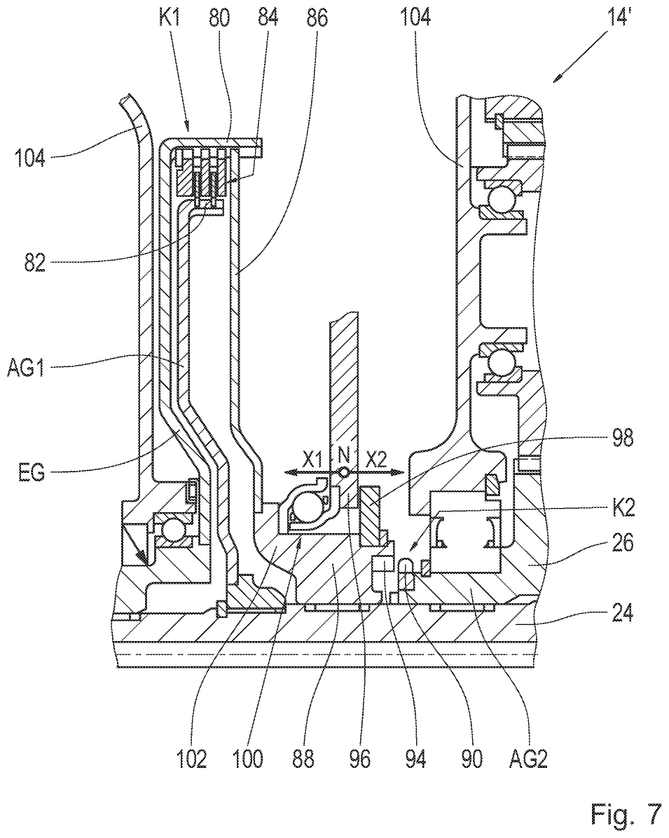

In FIG. 7, a further embodiment of a dual-clutch assembly 14′ is shown, which generally corresponds to the dual-clutch assembly 14 from FIG. 6 with respect to configuration and mode of operation. Identical elements are therefore labeled with identical reference characters. In the following, essentially, the differences are explained.

It is apparent, on the one hand, that, in the dual-clutch assembly 14′ from FIG. 7, the piston 86 is coupled to the input element EG in a rotationally fixed manner and, in particular, in the area of the outer disk carrier 80. The piston 86 is rotationally fixed to the sliding element 88, which, in the dual-clutch assembly 14′, is axially displaceably and rotatably mounted at an outer circumference of the first input shaft 24.

The clutch spline 90 is formed at an axial end of a shaft stub, which forms the second output element AG2. The second output element AG2 is rigidly connected to the second input shaft 26, which, as a hollow shaft, is arranged around the first input shaft 24.

The clutch spline 90 is formed at an outer circumference of this shaft stub.

On the other hand, the sliding element 88 includes the clutch spline 94 in the area of an inner circumference of an axial projection such that the clutch spline 94 is slid onto the clutch spline 90 during the establishment of the second engagement position X2.

The sliding element 88 has a first shoulder 98, which is rigidly connected to the sliding element 88 and forms a portion of the synchronizer sleeve groove 96 and, particularly, the axial portion, by which an actuating unit S1 (not shown in greater detail in FIG. 7) applies an axial load onto the sliding element 88 in order to move the sliding element 88 into the second engagement position X2.

On the other hand, the sliding element 88 has a second shoulder 102 and an axial bearing 100. The axial bearing 100 includes a bearing element, which forms a portion of the synchronizer sleeve groove 96, and a further element, which rests against the second shoulder 102. The actuating unit S1 engaging into the synchronizer sleeve groove 96 therefore applies an axial load via this axial bearing 100 onto the sliding element 88 and, consequently, onto the piston 86 in order to engage the first clutch K1.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid drive train

12 internal combustion engine

14 clutch assembly

16 hybrid transmission arrangement

18 power distribution unit

20 driven wheels

22 control device

24 first input shaft

26 second input shaft

28 output shaft

30 output gear set

32 first sub-transmission

34 second sub-transmission

36 first gear set (first forward gear step 1)

38 second gear set (third forward gear step 3)

40 first gearshift clutch assembly

42 third gear set (fifth forward gear step 5)

48 fourth gear set (second forward gear step 2)

50 fifth gear set (fourth forward gear step 4)

52 second gearshift clutch assembly

56 first electric machine

58 first pinion (first machine pinion)

59 first intermediate gear

60 second electric machine

62 second pinion (second machine pinion)

63 second intermediate gear

66 third gearshift clutch assembly

70 first gearwheel (first machine gearwheel)

72 second gearwheel (second machine gearwheel)

A1 first axis

A2 second axis

A3 third axis

A4 fourth axis

A5 fifth axis

A first gearshift clutch

B fourth gearshift clutch

C second gearshift clutch

D fifth gearshift clutch

E third gearshift clutch

K1 first clutch of clutch assembly

K2 second clutch of clutch assembly

EG input element

AG1 first output element

AG2 second output element

K3 third clutch

S1-S4 actuating units

P parking interlock gear

80 outer disk carrier

82 inner disk carrier

84 disk pack

86 piston

88 sliding element

90 clutch spline (26)

94 clutch spline (88)

96 synchronizer sleeve groove for S1

98 1st shoulder

100 axial bearing

102 2nd shoulder

104 housing

X1 engagement position K1

X2 engagement position K2

N neutral position

1-14. (canceled)

15. A clutch assembly (14) for a motor vehicle powertrain (10), comprising:
a first clutch (K1) having a first output element (AG1), the first clutch (K1) being a friction-locking clutch;
a second clutch (K2) having a second output element (AG2), the second clutch (K2) being a form-locking clutch (K2), the first clutch (K1) and the second clutch (K2) having a shared input element (EG); and
a single sliding element (88) associated with the first clutch (K1) and the second clutch (K2), the sliding element (88) being movable by a single actuating unit (S1) between a first engagement position (X1) and a second engagement position (X2) axially offset from the first engagement position (X1),
wherein the first clutch (K1) is engaged when the sliding element (88) is in the first engagement position (X1) and the second clutch (K2) is engaged when the sliding element (88) is in the second engagement position (X2).

16. The clutch assembly of claim 15, wherein the sliding element (88) has a neutral position (N) axially between the first and second engagement positions (X1, X2), the first clutch (K1) and the second clutch (K2) being disengaged when the sliding element (88) is in the neutral position.

17. The clutch assembly of claim 15, wherein the first clutch (K1) includes a piston (86), a friction interface arrangement (84) of the first clutch (K1) being compressible by the piston (86) to establish a frictional connection.

18. The clutch assembly of claim 17, wherein the piston (86) is rotationally fixed to the sliding element (88).

19. The clutch assembly of claim 15, wherein the sliding element (88) includes an axial bearing (100), the axial bearing (100) allowing the actuating unit (S1) to move the sliding element (88) toward the first engagement position (X1) to engage the first clutch (K1).

20. The clutch assembly of claim 19, wherein the sliding element (88) has a second shoulder (102), the axial bearing (100) being arranged at the second shoulder (102).

21. The clutch assembly of claim 15, wherein the sliding element (88) has a first shoulder (98) against which the actuating unit (S1) pushes to move the sliding element (88) into the second engagement position (X2) to engage the second clutch (K2).

22. A powertrain (10) for a motor vehicle comprising the clutch assembly (14) of claim 15, the powertrain (10) further comprising:
a transmission arrangement (16) including a first sub-transmission (32) and a second sub-transmission (34),
wherein a first input shaft (24) of the first sub-transmission (32) is connected to the first output element (AG1), and
wherein a second input shaft (26) of the second sub-transmission (34) is connected to the second output element (AG2).

23. The powertrain of claim 22, further comprising one or both of:
a first electric machine (56) connected to the first input shaft (24), and
a second electric machine (60) connected to the second input shaft (26).

24. The powertrain of claim 23, further comprising:
a third clutch (K3) for selectively connecting the first sub-transmission (32) and the second sub-transmission (34); and
a gearshift clutch (E; C) for engaging a gear set (42; 38″) of the first sub-transmission (32),
wherein the third clutch (K3) and the gearshift clutch (E; C) form a gearshift clutch assembly (66; 66″).

25. The powertrain of claim 23, wherein the first electric machine (56) is connected to the first input shaft (24) via a gear-step gear set (38; 42″) of the first sub-transmission (32), and
wherein the second electric machine (60) is connected to the second input shaft (26) via a gear-step gear set (50) of the second sub-transmission (34).

26. The powertrain of claim 22, wherein the first sub-transmission (32) has three gear sets (36, 38, 42), each of the three gear sets being associated with a respective odd forward gear step, and
wherein the second sub-transmission (34) has two or three gear sets (48, 50), each of the two or three gear sets being associated with a respective even forward gear step.

27. A method for operating the powertrain of claim 22, the method, during an internal combustion engine-driven operation or a hybrid operation, comprising:
engaging the first clutch (K1) to use a gear step of the first sub-transmission; and
engaging the first clutch (K1) and a third clutch (K3) to use a gear step of the second sub-transmission.

28. The method of claim 27, wherein, during a serial operation, the method comprises:
disengaging the first clutch (K1);
engaging the second clutch (K2);
operating a second electric machine (60) as a generator by driving the second electric machine (60) by internal combustion engine-generated power with the second clutch engaged (K2); and
providing input power from a first electric machine (56) to the transmission arrangement (16) for establishing a driving operation with the first clutch (K1) disengaged and with the second clutch engaged (K2).
